(19) United States
(12) Patent Application Publication
(10) Pub. No.: US 2026/0124970 A1
(43) Pub. Date: May 7, 2026

(54) CHILD RESTRAINT HAVING A LATCH ADJUSTMENT SYSTEM

(71) Applicant: Dorel Juvenile Group, Inc., Foxboro, MA (US)

(72) Inventor: Grant M. MASON, Wrentham, MA (US)

(21) Appl. No.: 19/382,552

(22) Filed: Nov. 7, 2025

Related U.S. Application Data
(60) Provisional application No. 63/717,569, filed on Nov. 7, 2024.
(60) Provisional application No. 63/762,922, filed on Feb. 25, 2025.

(51) Int. Cl. B60N 2/28; B60N 2/10

(52) U.S. Cl. CPC B60N 2/2806; B60N 2/10; B60N 2/2821; B60N 2/2869

(57) ABSTRACT

A child restraint includes a seat base adapted to rest on a vehicle seat and a juvenile seat coupled to the vehicle seat and formed to include a child receiving space configured to hold a child. The child restraint further includes an anchor latch system including a first latch buckle adapted to attach to a first latch anchor included in the vehicle seat and a second latch buckle adapted to attach to a second latch anchor included in the vehicle seat.

### PRIORITY CLAIM

This application claims priority under 35 U.S.C. §119(e) to U.S. Provisional Patent Application No. 63/717,569 , filed Nov. 7, 2024, and U.S. Provisional Patent Application No. 63/762,922 , filed Feb. 25, 2025, the disclosure of each of which is expressly incorporated by reference herein in its entirety.

### BACKGROUND

The present disclosure relates to a child safety device, and particularly to child car seat. More particularly, the present disclosure relates to a child car seat including features to secure the child car seat to a vehicle seat.

### SUMMARY

According to the present disclosure, a child restraint includes a seat base adapted to rest on a vehicle seat and a juvenile seat coupled to the vehicle seat and formed to include a child receiving space configured to hold a child. The child restraint further includes an anchor latch system including a first latch buckle adapted to attach to a first latch anchor included in the vehicle seat and a second latch buckle adapted to attach to a second latch anchor included in the vehicle seat.

In illustrative embodiments, the anchor latch system is an adjustable anchor latch system. The adjustable anchor latch system further includes a latch movement controller coupled to the first latch buckle and the second latch buckle and configured to control movement of the first latch buckle and the second latch buckle in a first, loosening direction away from the seat base and a second, tightening direction toward the seat base.

In illustrative embodiments, the latch movement controller includes a first buckle lock configured to block movement of the first latch buckle in the loosening direction, a second buckle lock spaced apart from the first buckle lock and configured to block movement of the second latch buckle in the loosening direction, and a strap assembly coupled to the first latch buckle and the second latch buckle. The strap assembly is configured to move the first latch buckle and the second latch buckle in the tightening direction simultaneously in response to movement of the strap assembly in the tightening direction.

In illustrative embodiments, the juvenile seat is mounted to the seat base for pivotable movement relative to the seat base about a vertical pivot axis between a forward-facing orientation and a rearward-facing orientation. The latch movement controller includes an adjustment strap configured to move the first latch buckle and the second latch buckle in the tightening direction simultaneously in response to movement of the adjustment strap in the tightening direction. The adjustment strap is positioned within an interior cavity of the seat base beneath the juvenile seat and exiting the interior cavity at a front end of the seat base.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a side elevation and diagrammatic view of a child restraint including a seat base adapted to rest on a vehicle seat, a juvenile seat supported by the seat base on the vehicle seat in a rearward-facing orientation, and an adjustable anchor latch system coupled to the seat base and configured to mount with the vehicle seat to secure the child restraint to the vehicle seat;

FIG. 2 is a side elevation and diagrammatic view of the child restraint showing the juvenile seat in a forward-facing orientation after pivoting the juvenile seat relative to the seat base about a vertical axis;

FIG. 3 is a perspective view of the seat base with the juvenile seat omitted and portions of the seat base with transparency to show the adjustable anchor latch system including a first latch buckle, a second latch buckle, and a latch movement controller coupled to the first latch buckle and the second latch buckle and configured to control movement of the first latch buckle and the second latch buckle in a first, loosening direction away from the seat base and a second, tightening direction toward the seat base, the latch movement controller including a first buckle lock configured to block movement of the first latch buckle in the loosening direction, a second buckle lock spaced apart from the first buckle lock and configured to block movement of the second latch buckle in the loosening direction, a strap assembly coupled to the first latch buckle and the second latch buckle and configured to move the first latch buckle and the second latch buckle in the tightening direction simultaneously in response to movement of the strap assembly in the tightening direction;

FIG. 4 is a perspective and diagrammatic view of the seat base showing each latch buckle coupled to a respective buckle strap and an adjustment strap protruding from a front end of the seat base to be gripped and pulled by a user to tighten both of the buckle straps in unison;

FIG. 5 is a top view of the seat base with a top cover of the seat base removed to show the seat base including a base shell, a seat mount configured to mount the juvenile seat to the seat base, and a strap manifold coupled to the base shell and to the seat mount to support the seat mount in spaced apart relation to a lower cover of the base shell and provide an interior cavity vertically between a portion of the seat mount and the lower cover of the base shell to receive the strap assembly so that the strap assembly bypasses a travel path of the juvenile seat;

FIG. 6 is an enlarged view of a portion of FIG. 5 showing one of the buckle straps extending through a first passageway formed in the strap manifold, through the first buckle lock, and out of the seat base to the first latch buckle at a distal end of the buckle strap;

FIG. 7 is an enlarged view of the first buckle lock clamped on the first buckle strap in a locked position to block movement of the first buckle strap outward away from the seat base, and showing a first lock actuator engaged with a lever of the buckle lock to move the buckle lock to an unlocked position upon actuation of the first lock actuator;

FIG. 8 is a side elevation view of portions of the adjustable latch anchor system showing the first buckle strap routed through the first strap passageway formed in the strap manifold and engaged with a plurality of rollers to facilitate movement of the first buckle strap relative to the strap manifold during tightening and loosening of the strap assembly;

FIG. 9 is a perspective view of portions of the child restraint showing the seat base further including a recline foot coupled to a lower end of the base shell and moveable relative to the base shell to adjust a recline orientation of the seat base and the juvenile seat relative to the underlying vehicle seat; and

FIG. 10 is a cross section of the child restraint taken along line 10-10 in FIG. 5 showing the strap assembly routed into the interior cavity and located vertically between a top wall of the strap manifold and at least a portion of the recline foot.

### DETAILED DESCRIPTION

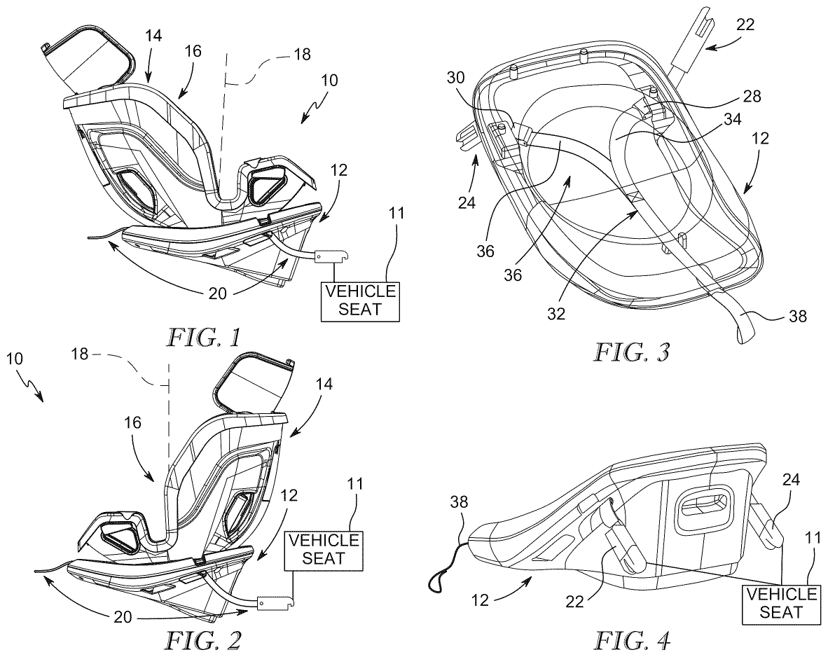

A child restraint 10 includes a seat base 12 adapted to rest on a vehicle seat 11 and a juvenile seat 14 coupled to the seat base 12. The juvenile seat 14 is formed to include a child-receiving space 16 configured to hold a child for transportation with the child restraint 10 in a vehicle. The juvenile seat 14 is configured to remain attached to the seat base 12 after assembly and is configured for use in both a rearward-facing orientation, as shown in FIG. 1, and a forward-facing orientation, as shown in FIG. 2. In the illustrative embodiment, the juvenile seat 14 is mounted to the seat base 12 for pivotable movement relative to the seat base 12 about a vertical axis 18 between the forward-facing orientation and the rearward-facing orientation.

In the illustrative embodiment, the child restraint 10 further includes an adjustable anchor latch system 20 configured to attach the seat base 12 to the vehicle seat 11 when the juvenile seat 14 is in the forward-facing orientation and the rearward-facing orientation. The adjustable anchor latch system 20 includes a first latch buckle 22, a second latch buckle 24, and a latch movement controller 26. The first latch buckle 22 is adapted to attach to a first latch anchor included in the vehicle seat 11. The second latch buckle 24 is adapted to attach to a second latch anchor included in the vehicle seat 11. The latch movement controller 26 is coupled to the first latch buckle 22 and the second latch buckle 24 and is configured to control movement of the first latch buckle 22 and the second latch buckle 24 in a first, loosening direction away from the seat base 12 and a second, tightening direction toward the seat base 12 opposite the loosening direction.

The latch movement controller 26 includes a first buckle lock 28, a second buckle lock 30, and a strap assembly 32 as shown in FIGS. 3 and 4. The first buckle lock 28 is configured to block movement of the first latch buckle 22 in the loosening direction. The second buckle lock 30 is spaced apart from the first buckle lock 28 and is configured to block movement of the second latch buckle 24 in the loosening direction. The strap assembly 32 is coupled to the first latch buckle 22 and the second latch buckle 24 and is configured to move the first latch buckle 22 and the second latch buckle 24 in the tightening direction simultaneously in response to movement of the strap assembly 32 in the tightening direction.

The first buckle lock 28 and the second buckle lock 30 are each moveable from a normally locked position to an unlocked position. The first and second buckle locks 28, 30 are movable independently from one another in the illustrative embodiment, but can be tied to one another to move from the locked position to the unlocked position in unison in other embodiments. The strap assembly 32 is moveable in the tightening direction while the first buckle lock 28 and the second buckle lock 30 are in the normally locked position but is blocked from moving in the loosening direction when the first and second buckle locks 28, 30 are in the locked position. In the illustrative embodiment, each buckle lock is an A-lock including a lever that is biased toward the locked position clamping portions of the strap assembly 32 between the lever and another part of the lock.

The strap assembly 32 includes a first buckle strap 34 coupled to the first latch buckle 22, a second buckle strap 36 coupled to the second latch buckle 24, and an adjustment strap 38 coupled to the first and second buckle straps 34, 36. One or both of the first and second buckle straps 34, 36 may be integral with the adjustment strap 38 while the other, or both, of the buckle straps 34, 36 is attached to the adjustment strap 38. The buckle strap(s) 34, 36 can be attached by any suitable means including sewing, fastening, adhering, etc.

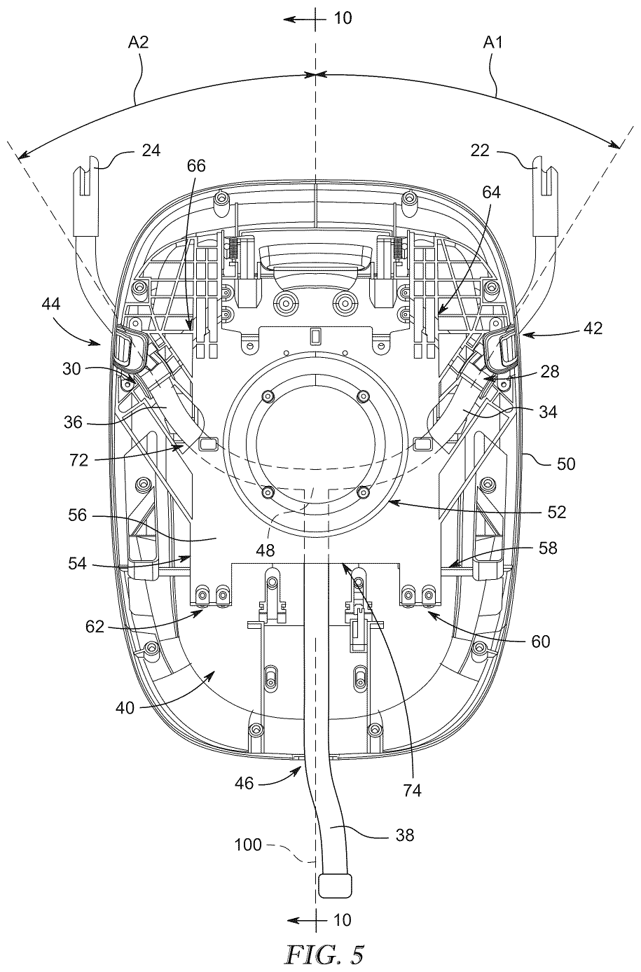

The seat base 12 is formed to include an interior cavity 40 as show in FIG. 5. The strap assembly 32 is at least partially received in the interior cavity 40 to bypass portions of the seat base 12 and the juvenile seat 14 that allow the juvenile seat 14 to pivot relative to the seat base 12 and to position the adjustment strap 38 in an area of the child restraint 10 that is accessible for a user while the juvenile seat 14 is in both the forward-facing orientation and the rearward-facing orientation. Other comparative car seats either do not have an adjustable latch system, or require portions of the seat to be separated from one another to access the latch system. The illustrative embodiment is structured to bypass movable components included in the child restraint 10 and position the adjustment strap 38 in an accessible location without the need to separate the juvenile seat 14 from the seat base 12.

The first buckle strap 34 enters the interior cavity 40 through a first aperture 42 in a first lateral side of the seat base 12. The second buckle strap 36 enters the interior cavity 40 through a second aperture 44 in a second lateral side of the seat base 12 opposite the first lateral side. The adjustment strap 38 enters the interior cavity 40 through a third aperture 46 in a front end of the seat base 12. The straps 34, 36, 38 are all joined at a junction point 48 within the interior cavity 40 and below the juvenile seat 14.

The adjustment strap 38 is parallel to a front-to-back centerline 100 of the seat base 12 when taut as shown in FIG. 5. The first buckle strap 34 is arranged to lie at a first angle A1 to the front-to-back centerline 100 of the seat base 12 when taut. The second buckle strap 36 is arranged to lie at a second angle A2 to the front-to-back centerline 100 of the seat base 12 when taut. The first and second angles A1, A2 are acute angles relative to a rear end of the seat base 12 and are substantially equal to one another. Such angles orient the straps 34, 36 toward the anchor points of the vehicle seat 11 to reduce bends in the straps 34, 36 and more evenly distribute loads from the straps 34, 36 over engagement points with the seat base 12.

The seat base 12 includes a base shell 50 adapted to rest on the vehicle seat 11, a seat mount 52, and a strap manifold 54 as shown in FIG. 5. The base shell 50 at least partially defines the interior cavity 40. The seat mount 52 is configured to at least partially attach the juvenile seat 14 to the seat base 12. The strap manifold 54 is located within the base shell 50 between the seat mount 52 and the strap assembly 32 and is configured to guide movement of the strap assembly 32 relative to base shell 50 and the juvenile seat 14 below the seat mount 52 and the juvenile seat 14.

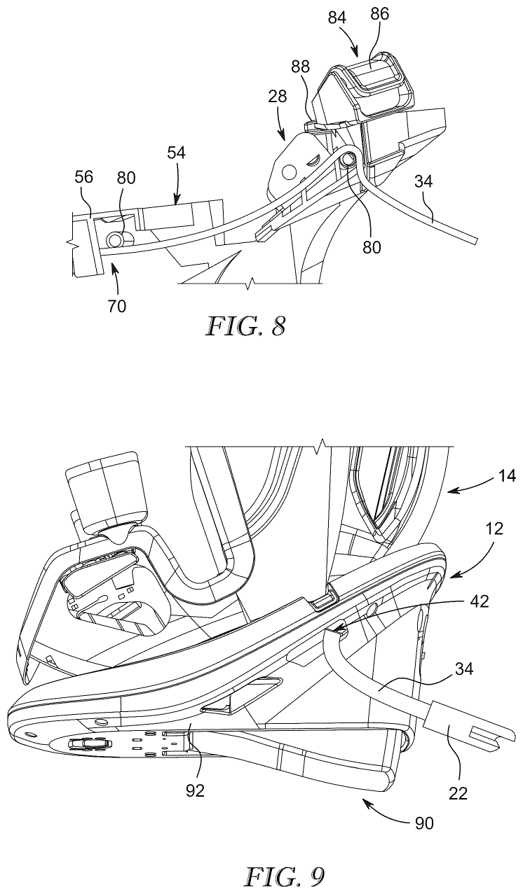

The strap manifold 54 includes a top wall 56 supporting the seat mount 52 thereon and a plurality of supports 58 extending between and interconnecting the top wall 56 and the base shell 50. The plurality of supports 58 are configured to support the top wall 56 in spaced apart relation to a lower end of the base shell 50 and at least partially define the interior cavity 40 vertically between the top wall 56 and the lower end of the base shell 50. The first buckle strap 34 extends into the strap manifold 54 through a first passageway 70 to the junction point 48 below the top wall 56. The second buckle strap 36 extends into the strap manifold 54 through a second passageway 72 to the junction point 48 below the top wall 56. The adjustment strap 38 extends out from under the top wall 56 and out of the interior cavity 40 through a third passageway 74 and out the front end of the base shell 12. The strap manifold 54 may further include a plurality of rollers 80 that each extend into at least one of the strap passageways 70, 72, 74 to guide sliding movement of the first and second buckle straps relative to the strap manifold 54 as shown in FIG. 8.

The plurality of supports 58 includes a first front support 60, a second front support 62, a first rear support 64, and a second rear support 66 as shown in FIG. 5. The first buckle strap 34 is located between the first front support 60 and the first rear support 64. The second buckle strap 36 is located between the second front support 62 and the second rear support 66. The adjustment strap 36 is located between the first and second front supports 60, 62.

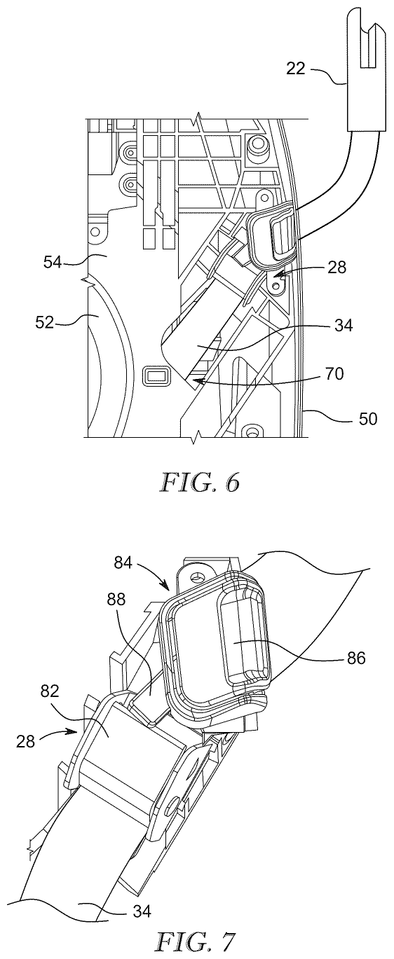

The first and second latch locks 28, 30 each include a lever 82 and an actuator 84 as shown in FIGS. 6-8. The lever 82 is biased to clamp on a respective buckle strap 34, 36 and block movement of the buckle strap in the loosening direction. The lever is angled and mounted such that the buckle strap can be pulled in the tightening direction without unlocking the lever 82. The actuator 84 includes a button or trigger 86 and a lever mover 88. The button 86 is located at least partially external to the base shell 50 to be accessed by a user and pressed or squeezed to move relative to the base shell 50. The lever mover is mounted to the button 86 and engages the lever 82. Pressing the button 86 causes movement of the lever mover 88 and, in turn, causes movement of the lever 82 to the unlocked position so the strap can be loosened. Illustratively, both the lever 82 and the lever mover 88 are located internal to the base shell 50 so that neither the lever 82 nor the lever mover 88 can be interfered with by a child.

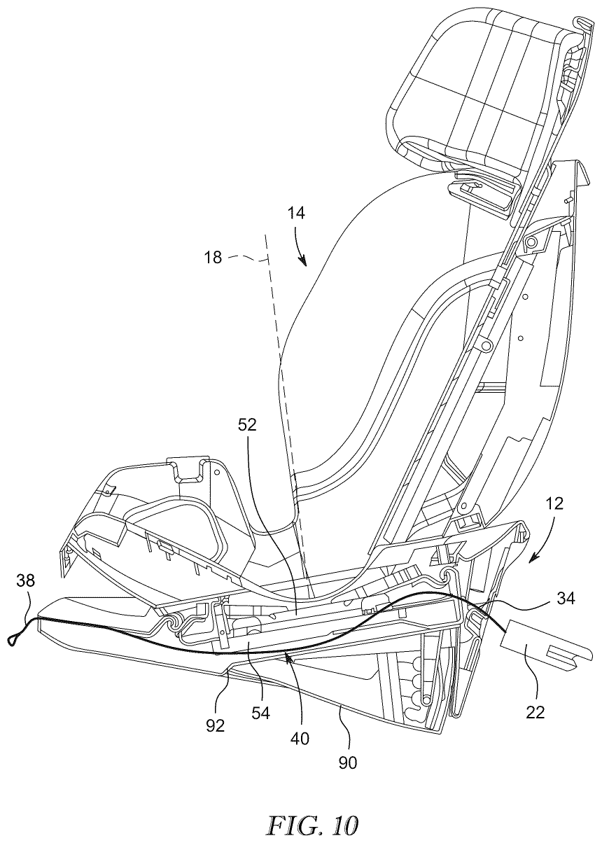

The seat base 12 may further include a seat recline foot 90 coupled to the base shell 50 as shown in FIGS. 9 and 10. The recline foot 90 is pivotable relative to the base shell 50 about a horizontal foot pivot axis 92 to change a recline orientation (i.e. a tilt angle) of the seat base 12 and the juvenile seat 14 relative to the vehicle seat 11. The strap assembly 32 is located at least partially vertically between the seat recline foot 90 and the seat mount 52.

A child restraint including an adjustable anchor latch system in accordance with the present disclosure is shown in FIGS. 1 and 2. The adjustable anchor latch system may be incorporated into a base of the child seat or restraint for use in a motor vehicle (not shown). The adjustable anchor latch system is configured to be coupled to motor vehicle LATCH (Lower Anchors and Tethers for Children) anchor points (not shown) located between the seat back and a seat base of a motor vehicle to secure the seat base to the motor vehicle seat.

As shown in FIGS. 1 and 2, the adjustable anchor latch system includes two LATCH buckles, a tether belt, two A-locks, and two release buttons. The LATCH buckles are configured to couple to respective motor vehicle LATCH anchor points in the motor vehicle. Each LATCH buckle is secured to an end of a respective latch strap of the tether belt. The A-locks are each positioned on the right and left sides of the base to receive a respective latch strap of the tether belt. The latch straps each pass through a respective A-lock.

Referring to FIGS. 1 and 2, the latch straps, after leaving the A-locks, merge to couple to an adjustment strap of the tether belt 16. The adjustment strap is coupled to opposite ends of the latch straps and exits out of the front of the base so that the LATCH buckles can be adjusted by a user with the adjustment strap via the latch straps. The release buttons are positioned on the right and left sides of the base to selectively release the A-locks.

To secure the base to the motor vehicle seat, a user couples the LATCH buckles to the motor vehicle LATCH anchor points. The user then pulls on an end of the adjustment strap at the front of the base until the base is tight and secured to the motor vehicle seat.

To release the base from the motor vehicle seat, a user presses the release buttons on both sides of the base either in unison or one at a time. Pressing the release buttons causes the A-locks to release to allow the latch straps to slack. Thus, the base can be moved to allow a user to release the LATCH buckles from the LATCH anchor points.

As shown in FIGS. 1 and 2, the A-locks and most of the tether belt are enclosed within the seat base. The end of the adjustment strap, the ends of the latch straps, the LATCH buckles, and the release buttons are coupled to the outer shell of or are external to the base to be accessible to a user so that the user can secure the base to or release the base from the motor vehicle seat.

In the illustrative embodiment, one of the latch straps and the adjustment strap are formed from one piece of material and the other latch strap is formed from a separate piece of material. Thus, the end of the other latch strap couples to said piece of material that forms the latch strap and the adjustment strap. In other embodiments, the adjustment strap may be a separate piece of material from the latch straps that couples to the ends of the latch straps.

1. A child restraint comprising:
a seat base adapted to rest on a vehicle seat,
a juvenile seat coupled to the vehicle seat and formed to include a child receiving space configured to hold a child, and
an adjustable anchor latch system including a first latch buckle adapted to attach to a first latch anchor included in the vehicle seat, a second latch buckle adapted to attach to a second latch anchor included in the vehicle seat, a latch movement controller coupled to the first latch buckle and the second latch buckle and configured to control movement of the first latch buckle and the second latch buckle in a first, loosening direction away from the seat base and a second, tightening direction toward the seat base,
wherein the latch movement controller includes a first buckle lock configured to block movement of the first latch buckle in the loosening direction, a second buckle lock spaced apart from the first buckle lock and configured to block movement of the second latch buckle in the loosening direction, and a strap assembly coupled to the first latch buckle and the second latch buckle and configured to move the first latch buckle and the second latch buckle in the tightening direction simultaneously in response to movement of the strap assembly in the tightening direction.

2. The child restraint of claim 1, wherein the first buckle lock and the second buckle lock are each moveable from a normally locked position to an unlocked position and the strap assembly is moveable in the tightening direction while the first buckle lock and the second buckle lock are in the normally locked position.

3. The child restraint of claim 1, wherein the strap assembly includes a first buckle strap coupled to the first latch buckle, a second buckle strap coupled to the second latch buckle, and an adjustment strap coupled to the first and second buckle straps.

4. The child restraint of claim 3, wherein the seat base is formed to include an interior cavity, and wherein the first buckle strap enters the interior cavity through a first aperture in a first lateral side of the seat base, the second buckle strap enters the interior cavity through a second aperture in a second lateral side of the seat base, and the adjustment strap enters the interior cavity through a third aperture in a front end of the seat base.

5. The child restraint of claim 4, wherein the adjustment strap is parallel to a front-to-back centerline of the seat base, the first buckle strap is arranged to lie at a first angle to the front-to-back centerline of the seat base, the second buckle strap is arranged to lie at a second angle to the front-to-back centerline of the seat base.

6. The child restraint of claim 5, wherein the first and second angles are acute angles relative to a rear end of the seat base.

7. The child restraint of claim 1, wherein the seat base includes a base shell adapted to rest on the vehicle seat and at least partially defining an interior cavity, a seat mount configured to at least partially attach the juvenile seat to the seat base, and a strap manifold located within the interior cavity between the seat mount and the strap assembly and configured to guide movement of the strap assembly relative to base shell and the juvenile seat below the seat mount and the juvenile seat.

8. The child restraint of claim 7, wherein the juvenile seat is configured to hold the child in a forward-facing orientation and a rearward-facing orientation and the juvenile seat is configured to be attached to the seat base at all times.

9. The child restraint of claim 7, wherein the strap assembly includes a first buckle strap coupled to the first latch buckle and extending into the strap manifold through a first aperture formed in a first lateral side of the base shell, a second buckle strap coupled to the second latch buckle and extending into the strap manifold through a second aperture formed in a second lateral side of the base shell, and an adjustment strap coupled to the first and second buckle straps at a junction point located directly beneath the seat mount and extending out of the interior cavity through a third aperture formed in a front end of the base shell.

10. The child restraint of claim 7, wherein the strap manifold includes a top wall supporting the seat mount thereon and a plurality of supports extending between and interconnecting the top wall and the base shell to support the top wall in spaced apart relation to a lower end of the base shell and at least partially define the interior cavity vertically between the top wall and the lower end of the base shell.

11. The child restraint of claim 10, wherein the plurality of supports includes a first front support, a second front support, a first rear support, and a second rear support, and the strap assembly includes a first buckle strap located between the first front support and the first rear support, a second buckle strap located between the second front support and the second rear support, and an adjustment strap located between the first and second front supports.

12. The child restraint of claim 10, wherein the strap manifold is formed to include a first strap passageway to receive a first buckle strap included in the strap assembly and a second strap passageway to receive a second buckle strap included in the strap assembly, and wherein the strap manifold further includes a plurality of rollers that each extend into at least one of the first strap passageway and the second strap passageway to guide sliding movement of the first and second buckle straps relative to the strap manifold.

13. The child restraint of claim 7, wherein the juvenile seat is coupled to the seat mount for pivotable movement relative to the seat base about a seat-pivot axis between a forward-facing orientation and a rearward-facing orientation, and the juvenile seat overlies the strap manifold in both the forward-facing orientation and the rearward-facing orientation and during pivoting of the juvenile seat relative to the seat base between the forward-facing orientation and the rearward-facing orientation.

14. The child restraint of claim 13, wherein the seat base further includes a seat recline foot coupled to the base shell and pivotable relative to the base shell about a horizontal foot pivot axis to change a recline orientation of the seat base and the juvenile seat, and wherein the strap assembly is located at least partially vertically between the seat recline foot and the seat mount.

15. A child restraint comprising:
a seat base adapted to rest on a vehicle seat,
a juvenile seat coupled to the vehicle seat and formed to include a child receiving space configured to hold a child, the juvenile seat mounted to the seat base for pivotable movement relative to the seat base about a vertical pivot axis between a forward-facing orientation and a rearward-facing orientation, and
an adjustable anchor latch system coupled to the seat base and including a first latch buckle adapted to attach to a first latch anchor included in the vehicle seat, a second latch buckle adapted to attach to a second latch anchor included in the vehicle seat, a latch movement controller coupled to the first latch buckle and the second latch buckle and configured to control movement of the first latch buckle and the second latch buckle in a first, loosening direction away from the seat base and a second, tightening direction toward the seat base,
wherein the latch movement controller includes an adjustment strap configured to move the first latch buckle and the second latch buckle in the tightening direction simultaneously in response to movement of the adjustment strap in the tightening direction, the adjustment strap positioned within an interior cavity of the seat base beneath the juvenile seat and exiting the interior cavity at a front end of the seat base.

16. The child restraint of claim 15, wherein the seat base includes a base shell adapted to rest on the vehicle seat and at least partially defining an interior cavity, a seat mount configured to at least partially attach the juvenile seat to the seat base, and a strap manifold located within the interior cavity between the seat mount and the strap assembly and configured to guide movement of the adjustment strap relative to base shell and the juvenile seat below the seat mount and the juvenile seat.

17. The child restraint of claim 16, wherein the latch movement controller further includes a first buckle lock configured to block movement of the first latch buckle in the loosening direction, a second buckle lock spaced apart from the first buckle lock and configured to block movement of the second latch buckle in the loosening direction, and a strap assembly including a first buckle strap coupled to the first latch buckle and extending in to the interior cavity, a second buckle strap coupled to the second latch buckle and extending in to the interior cavity, and the adjustment strap coupled to the first and second buckle straps at a junction point with in the interior cavity.

18. The child restraint of claim 17, wherein the strap manifold includes a top wall supporting the seat mount thereon and a plurality of supports extending between and interconnecting the top wall and the base shell to support the top wall in spaced apart relation to a lower end of the base shell and at least partially define the interior cavity vertically between the top wall and the lower end of the base shell.

19. The child restraint of claim 18, wherein the plurality of supports includes a first front support, a second front support, a first rear support, and a second rear support, and the strap assembly includes a first buckle strap located between the first front support and the first rear support, a second buckle strap located between the second front support and the second rear support, and the adjustment strap located between the first and second front supports.

20. The child restraint of claim 18, wherein the seat base further includes a seat recline foot coupled to the base shell and pivotable relative to the base shell about a horizontal foot pivot axis to change a recline orientation of the seat base and the juvenile seat, and wherein the junction point is located at least partially vertically between the seat recline foot and the top wall.
